(19) United States
(12) Patent Application Publication
(10) Pub. No.: US 2011/0184809 A1
(43) Pub. Date: Jul. 28, 2011

(54) Method and system for managing advertisments on a mobile device

(75) Inventors: Wade Beavers, Rochester, MN (US); David Borrillo, Rochester, MN (US); Joseph Sriver, Minneapolis, MN (US)

(73) Assignee: DoApp, Inc., Minneapolis, MN (US)

(21) Appl. No.: 12/802,525

(22) Filed: Jun. 7, 2010

Related U.S. Application Data
(60) Provisional application No. 61/184,594, filed on Jun. 5, 2009.

(51) Int. Cl. G06Q 30/00

(52) U.S. Cl. 705/14.64

(57) ABSTRACT

Methods and systems for distributing advertisements are disclosed. The system includes an advertisement data store for storing a set of advertisements. The system includes a content data store for storing a set of contents. The system includes an advertisement management server to select an advertisement and user content for bundling into a standardized publishing web feed. In embodiments, the advertisement management server transmits the web feed to a mobile device via a wireless network for display. The advertisement management server subsequently executes a user-selected action in conjunction with the user action data.

### CLAIM OF PRIORITY

This application claims priority to U.S. Provisional Application No. 61/184,594, entitled, “METHOD AND SYSTEM FOR MANAGING ADVERTISEMENTS ON A MOBILE DEVICE,” filed Jun. 5, 2009, which is incorporated by reference as if fully set forth herein.

### BACKGROUND

A type of mobile device can be a mobile phone. The mobile phone is a long-range, electronic device used for mobile voice or data communication over a network of specialized base stations known as cell sites. In addition to the standard voice function of a mobile phone, telephone, current mobile phones support additional services, such as SMS for text messaging, email, packet switching for access to the Internet, gaming, Bluetooth, infrared, camera with video recorder and MMS for sending and receiving photos and video, MP3 player, radio and GPS. Most current mobile phones connect, for example, to a cellular network of base stations, which is in turn interconnected to the public switched telephone network (PSTN).

Access to the Internet allows mobile phone and other mobile device users to subscribe to regularly updated content, such as Really Simple Syndication (RSS) web feeds. RSS is a family of web feed formats used to publish frequently updated works (e.g., blog entries, news headlines, audio, and video, etc.) in a standardized format. An RSS document (which is called a “feed,”, “web feed,” or “channel”) includes full or summarized text, plus metadata such as publishing dates and authorship. In one example, web feeds benefit publishers by letting them syndicate content automatically. They benefit readers who want to subscribe to timely updates from favored websites or to aggregate feeds from many sites into one place. RSS feeds can be read using software called an “RSS reader,” “feed reader,” or “aggregator,” which can be web-based, desktop-based, or mobile-device-based. An RSS application executes on the mobile device and displays new content when received.

In addition to subscribed content, Internet access also allows mobile phone users to also view advertisements. Such advertisements can be text-only or include multimedia content such as graphics, animation, audio, etc. Given the number of parties (such as advertisers, publishers, users, etc.) and the variability of the advertisement content, it is becoming increasingly onerous to provide an overall management of the advertising process on mobile devices.

### BRIEF DESCRIPTION OF DRAWINGS

The features and objects of the present disclosure will become more apparent with reference to the following description taken in conjunction with the accompanying drawings wherein like reference numerals denote like elements and in which:

FIG. 1A illustrates a first example screen shot of a mobile device with an advertisement.

FIG. 1B illustrates a second example screen shot of a mobile device with an advertisement.

FIG. 1C illustrates an example screen shot of a “coupon” user action on a mobile device.

FIG. 1D illustrates an example screen shot of a “share” user action on a mobile device.

FIG. 1E illustrates an example screen shot of a “website” user action on a mobile device.

FIG. 1F illustrates an example screen shot of a “map location” user action on a mobile device.

FIG. 1G illustrates an example screen shot of a “show video” user action on a mobile device.

FIG. 1H illustrates a third example screen shot of a mobile device with an advertisement.

FIG. 1I illustrates a fourth example screen shot of a mobile device with an advertisement.

FIG. 1J illustrates a first example screen shot of an advertisement management system.

FIG. 1K illustrates a second example screen shot of an advertisement management system.

FIG. 1L illustrates a third example screen shot of an advertisement management system.

FIG. 1M illustrates a fourth example screen shot of an advertisement management system.

FIG. 1N illustrates a fifth example screen shot of an advertisement management system.

FIG. 1O illustrates a sixth example screen shot of an advertisement management system.

FIG. 1P illustrates a seventh example screen shot of an advertisement management system.

FIG. 1Q illustrates an eighth example screen shot of an advertisement management system.

FIG. 1R illustrates a ninth example screen shot of an advertisement management system.

FIG. 2 illustrates an example prior art workstation interacting with an advertisement management system.

FIG. 3 illustrates an example mobile device for displaying web feeds and advertisements.

FIG. 4 illustrates an example server for providing an advertisement management system.

FIG. 5 illustrates an example system for managing advertisements on mobile devices.

FIG. 6 illustrates an example procedure for defining an advertisement campaign for executing.

### DETAILED DESCRIPTION

Methods and systems for collecting, providing, and managing advertisements for display on mobile devices are disclosed herein. In embodiments, a publisher provides timely content to one or more mobile devices via an RSS feed. A management server inserts publisher-approved advertisements at periodic intervals into the RSS feed for distribution to the mobile devices. In embodiments, advertisers can submit potential advertisements to the publisher for distribution via the RSS feed. The advertisements can be displayed on the mobile devices with a variety of calls to action, including requesting additional information, retrieving a coupon, displaying a location, sharing an advertisement, requesting a reminder, etc. Furthermore, the advertisements can be targeted by the publisher in a variety of ways, including by user demographic and geographic location.

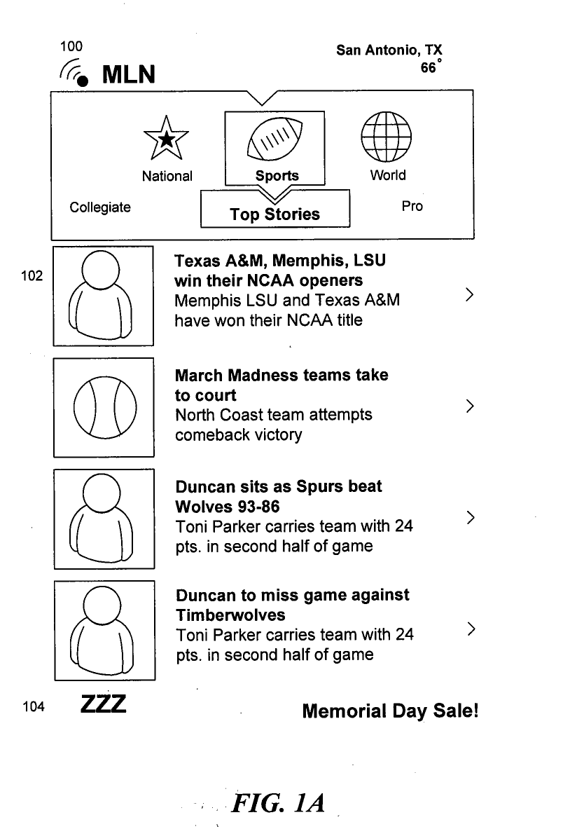

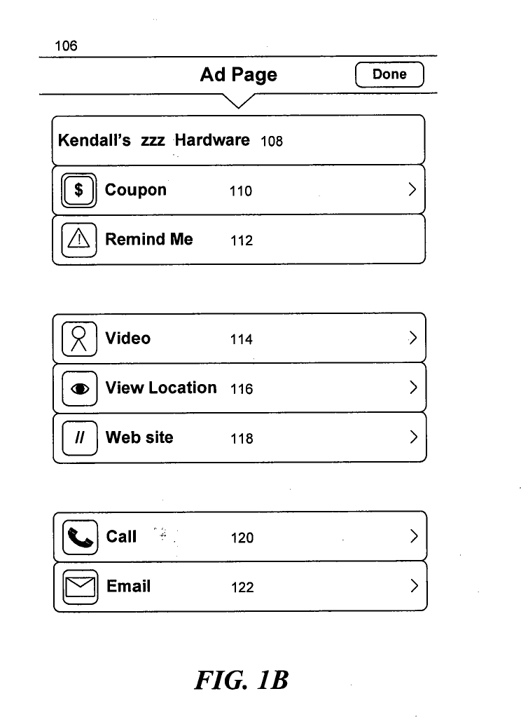

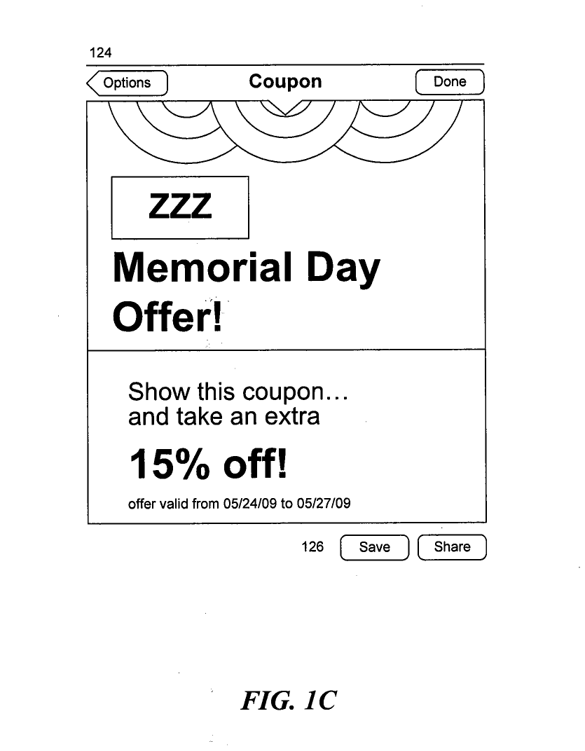

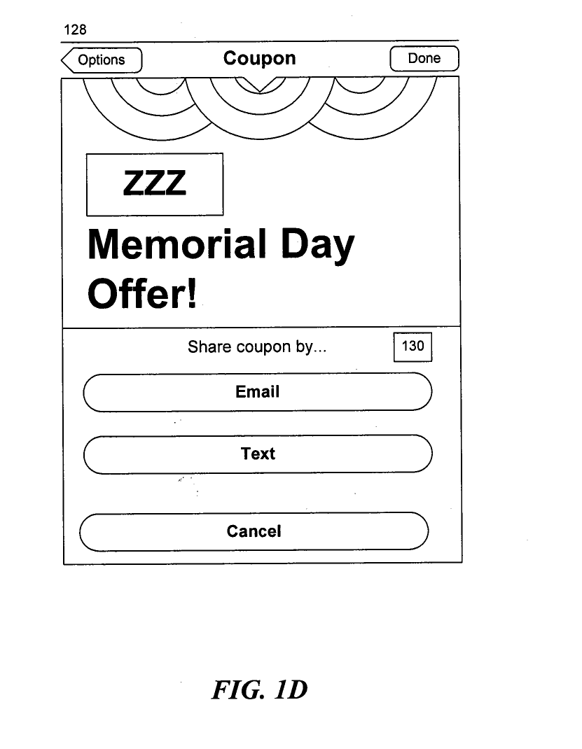

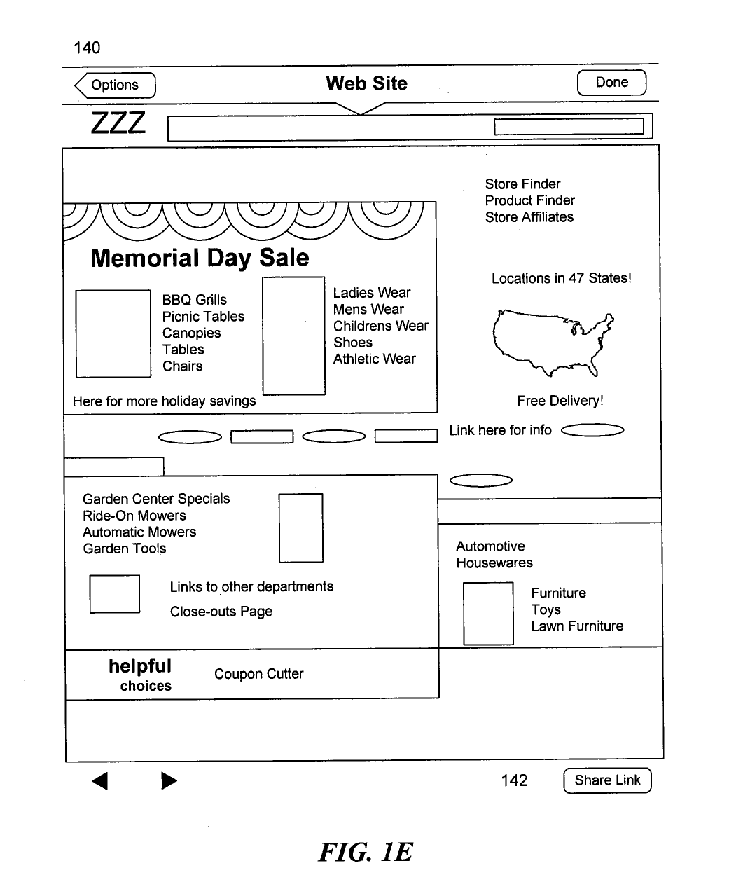

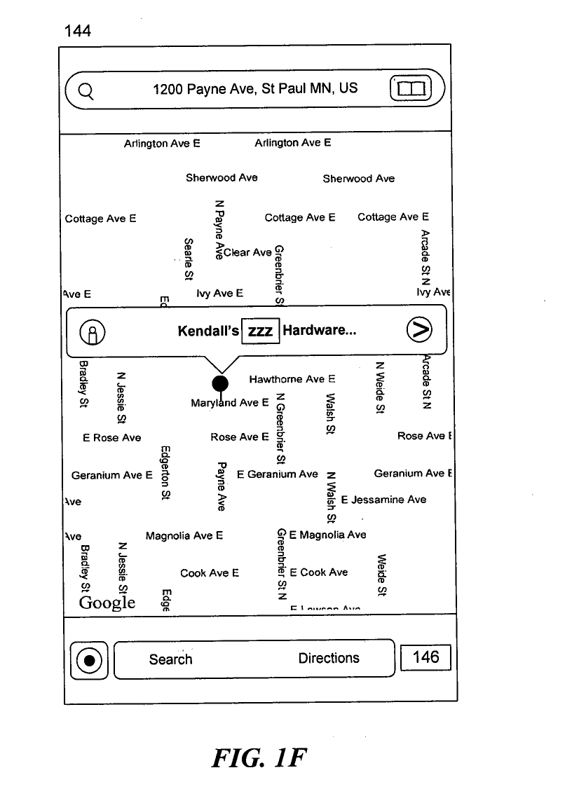

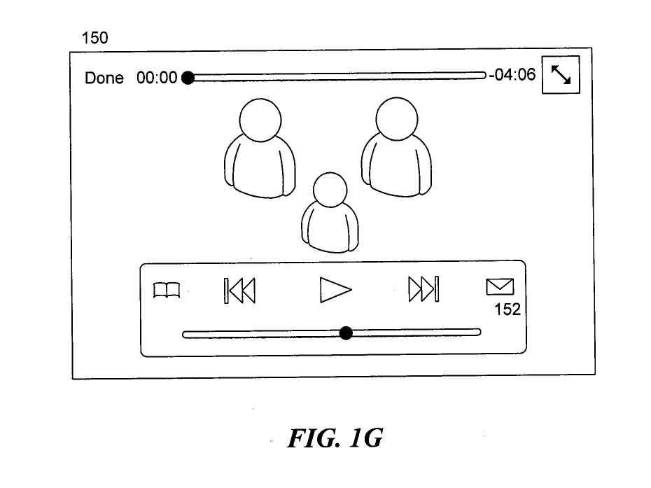

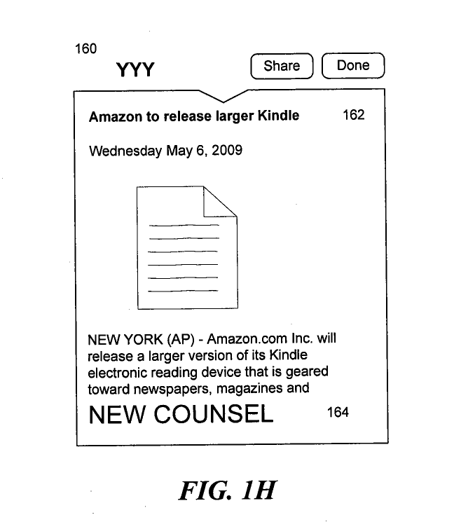

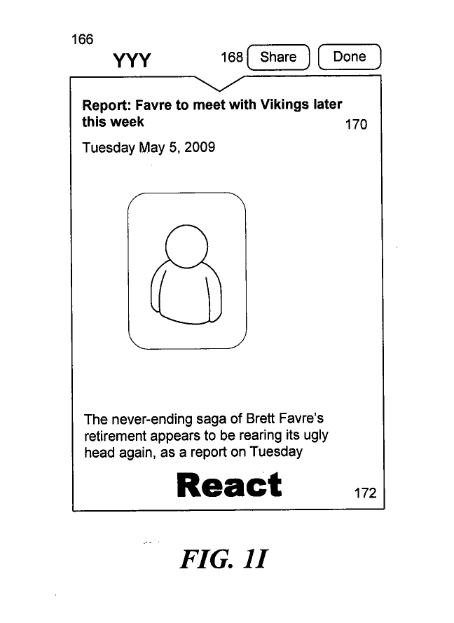

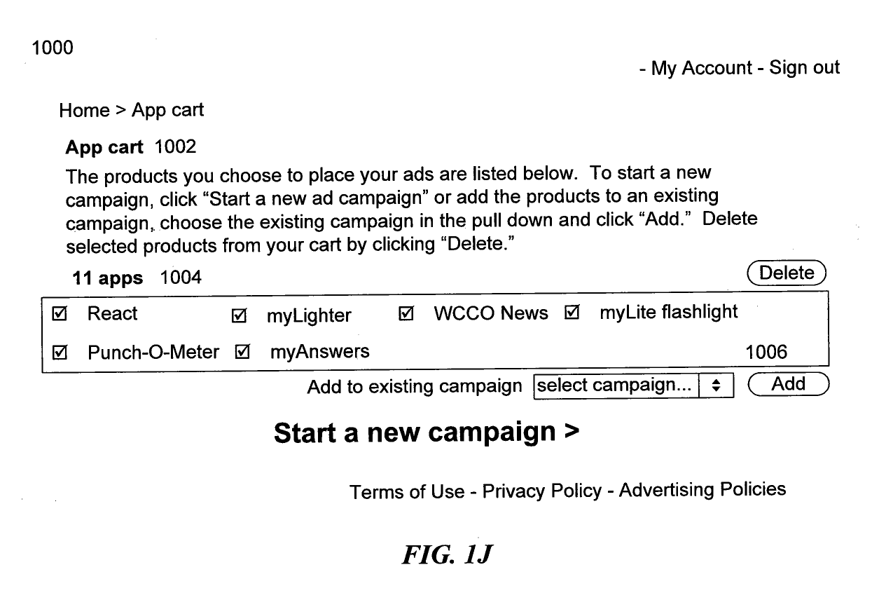

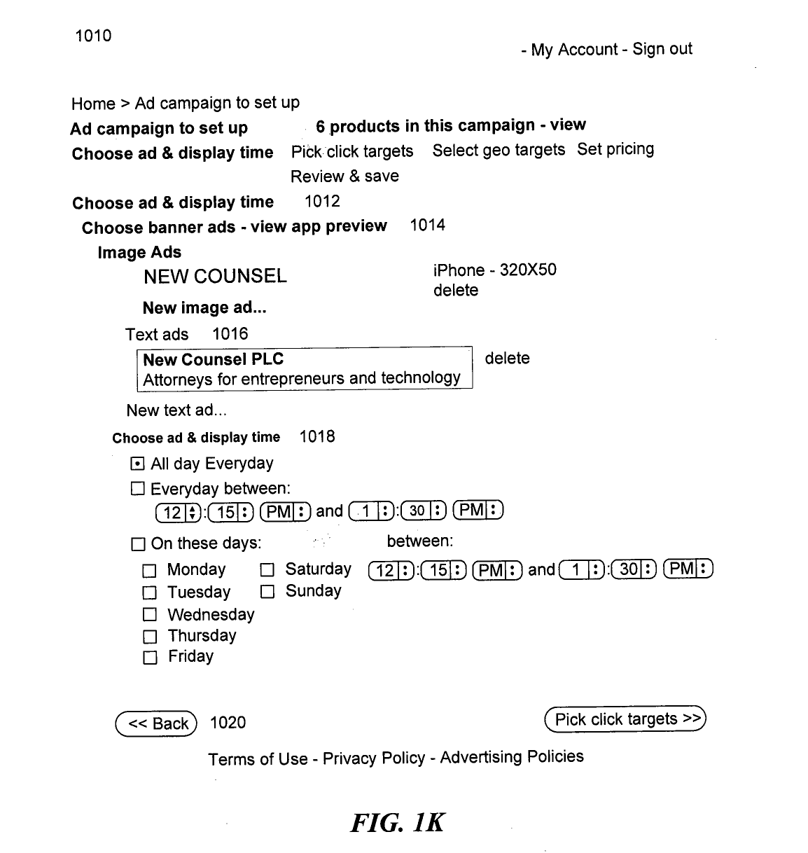

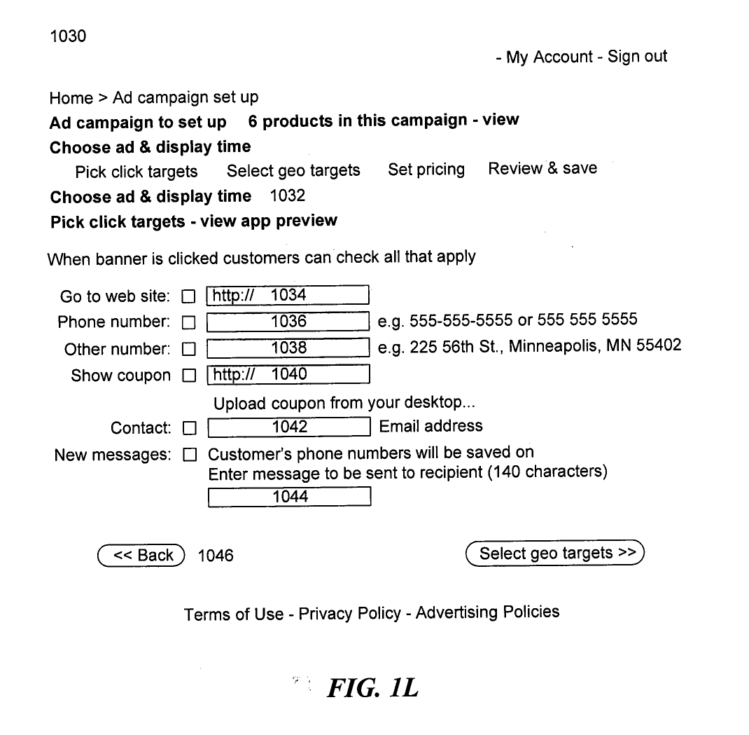

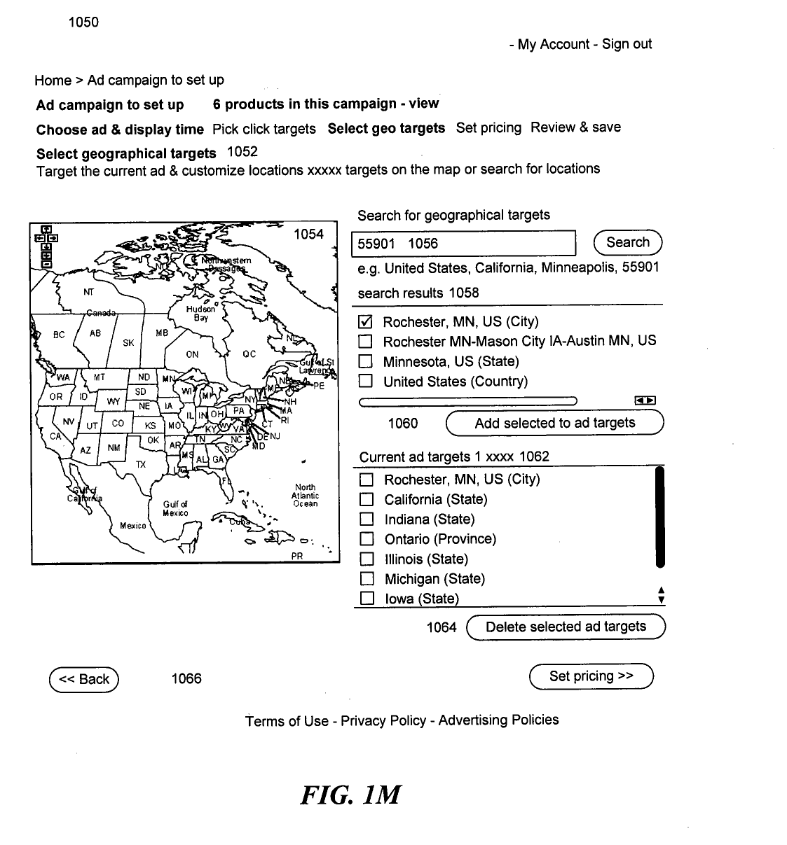

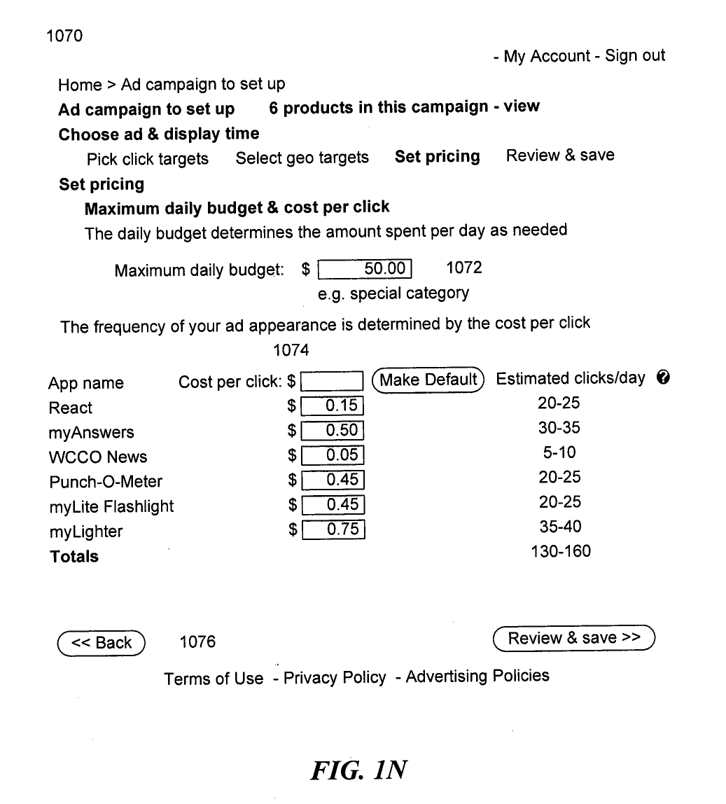

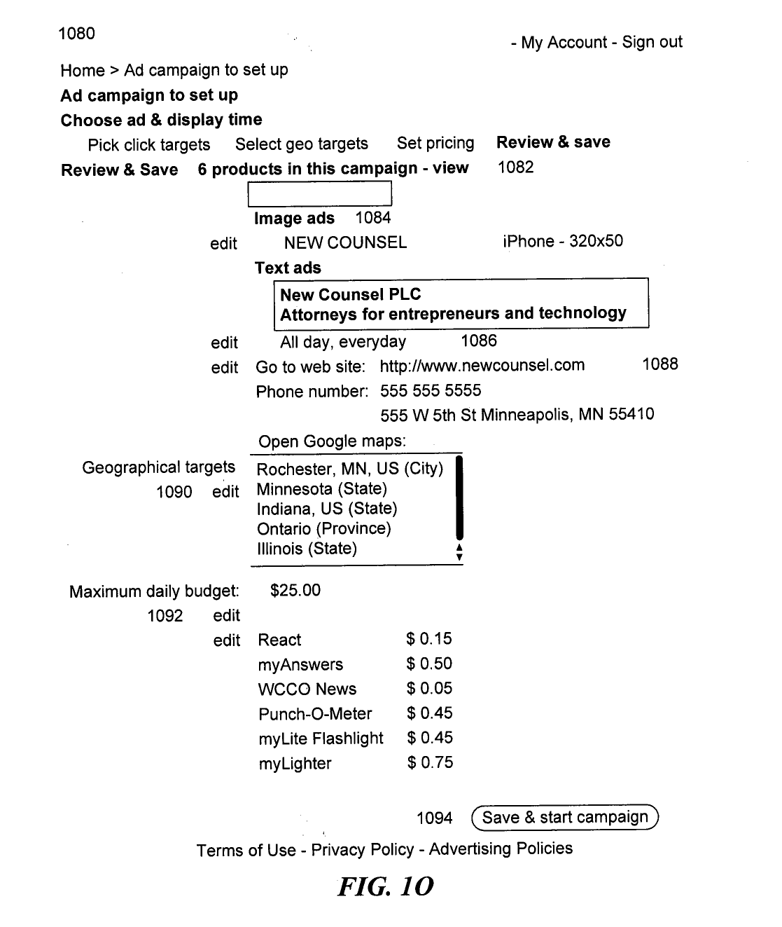

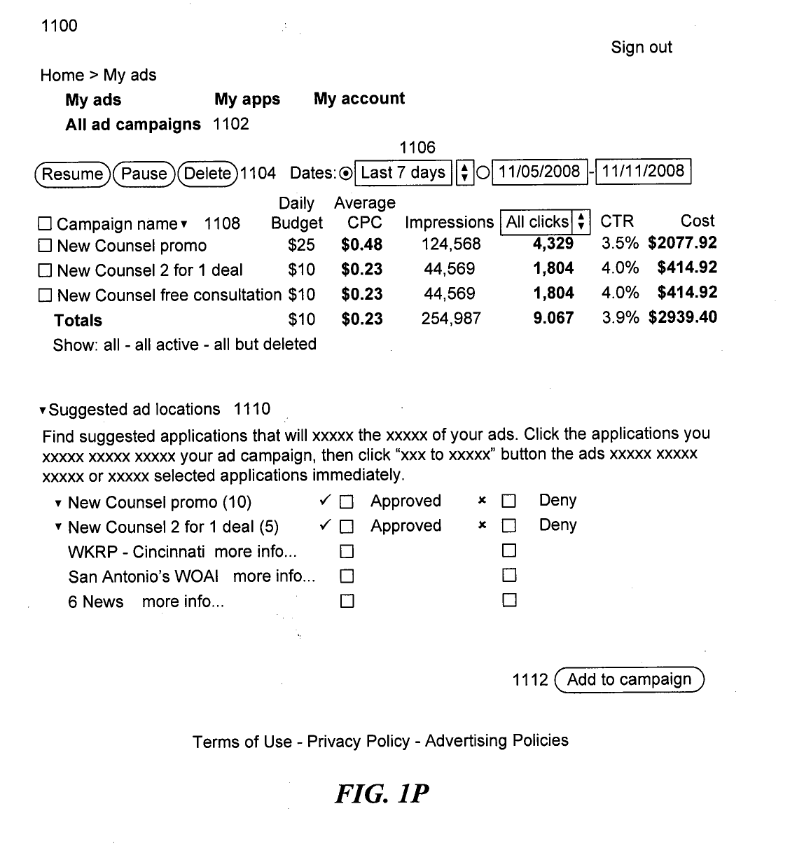

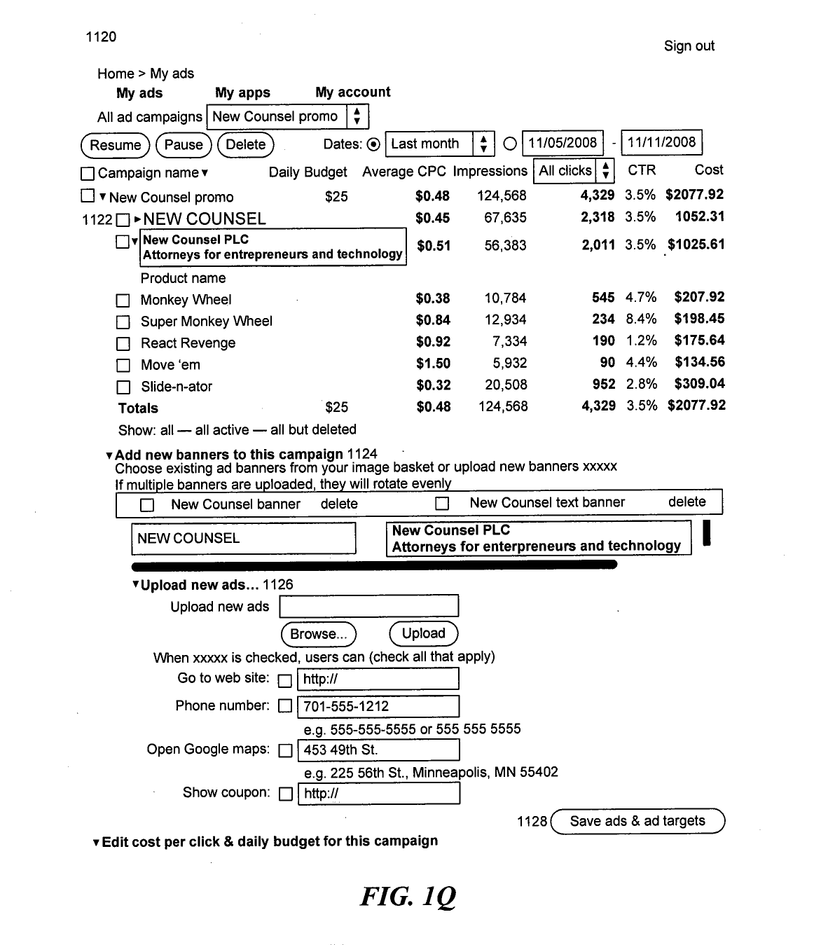

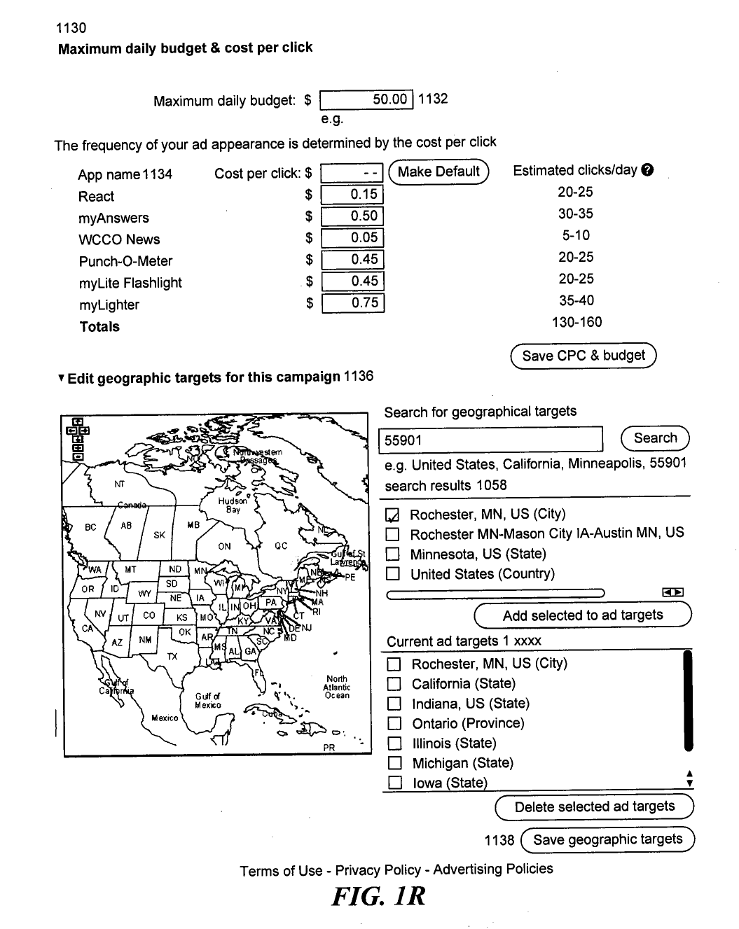

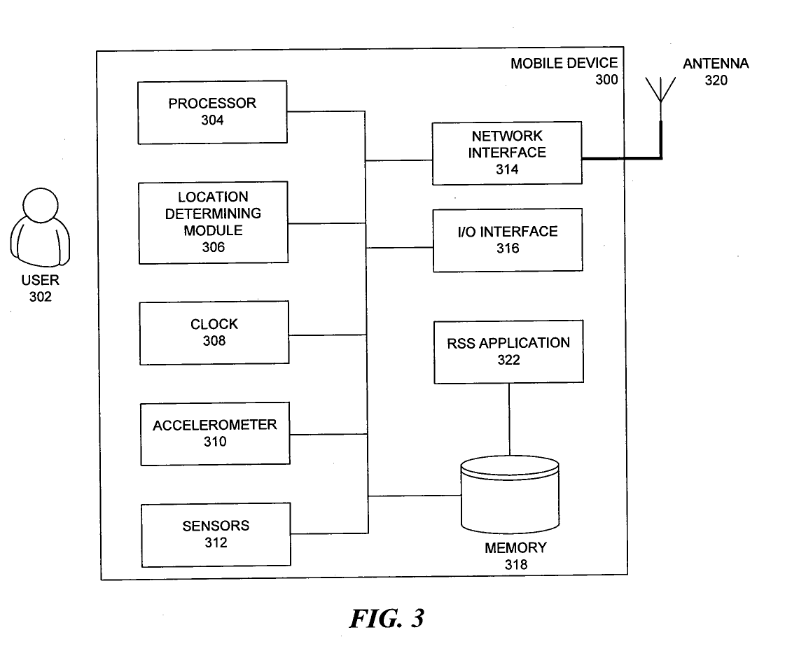

FIG. 1A illustrates a first example screen shot of a mobile device with an advertisement. For example, the screen shot 100 can be displayed by an RSS application executing on a mobile device as illustrated in FIG. 3.

The screen shot 100 depicts multiple content 102. In exemplary embodiments, content can be stories or articles related to a user-specified topic, such as sports. The content provides an image, a headline, and a brief synopsis of an article. The user may click on the content to view the full article. Alternatively, content can be other material, as discussed below.

The screen shot 100 includes an advertisement 104. The advertisement can include a merchant name “777” and a text description of “Memorial Day Sale!” It will be appreciated that the advertisement 104 can take many forms, including graphics, text, or other types of some multimedia combination. The advertisement 104 can take any form that conveys information to be advertised. It will also be appreciated that alternative arrangements of content and advertisements are possible, such as placing the advertisement among the content. As illustrated in the example of FIG. 1A, the advertisement is placed at the bottom of the screen. In another example embodiment, the advertisement may be displayed on the screen at a specified interval among the content. A user can click on or otherwise select the advertisement 104, which will bring up advertisement options as illustrated below.

FIG. 1B illustrates a second exemplary screenshot 106 of a mobile device with an advertisement. The screenshot 106 illustrates advertisements options available to a user. Each advertisement can be associated with a plurality of calls-to-action, thus encouraging user interaction with the advertisement and increasing user response rates.

In embodiments, the screenshot 106 includes an advertiser name 108. For example, the advertiser name 108 can be text, graphics, or multimedia. The screen shot 106 may further include a “coupon” option 110. The user has the option to view a coupon associated with the advertisement, as illustrated below.

In embodiments, screenshot 106 includes a “remind me” option 112. The user can request a reminder regarding the advertisement at a later time. For example, the user can request a SMS message, a phone call, an appointment, or another form of reminder at a specified time in the future. In some instances, screenshot 106 includes a “video” option 114. Using this option, the user can view a video associated with the advertisement, as illustrated below.

In embodiments, screenshot 106 includes a “view location” option 116. The user can view a map location associated with the advertisement, as illustrated below. For example, the option can display a location on a mapping application. In embodiments, screenshot 106 includes a “web site” option 118. The user can view a web site associated with the advertisement, as illustrated below. For example, the web site can be a merchant's web site offering more details on the advertisement.

In embodiments, screenshot 106 includes a “call” option 120. The user can call a number associated with the advertisement. For example, the advertisement can be associated with a contact phone number which the user can call with questions, make reservations, or otherwise interact with the advertiser. Further, in some instances, screenshot 106 includes an “email” option 122. The user can email an email address associated with the advertisement. For example, the advertisement can be associated with an email address which the user can contact with questions or otherwise interact with the advertiser.

FIG. 1C illustrates an exemplary screenshot of a “coupon” user action 124 on a mobile device. The screenshot 124 can display a coupon including multimedia such as graphics, audio, text, and other forms of information. The coupon can include a merchant name, a text description of the offer, background images, etc. In embodiments, screenshot 124 can include “save” and “share” buttons 126. The save button can allow the user to save the coupon for later use or viewing on the mobile device. The share button can allow the user to share the coupon with other users, as illustrated below.

FIG. 1D illustrates an example screen shot of a “share” user action on a mobile device. The screen shot 128 can include details on the coupon, such as a merchant name and an advertisement description. The description can also include graphics, audio, text, and other forms of information. In embodiments, coupon sharing options 130 can include email and SMS text messages. For example, the user can share the coupon with another user via an email or a text message. In an alternative embodiment, other sharing mechanisms can be used, such as an automated phone call to another user's phone number.

FIG. 1E illustrates an exemplary screenshot of a “website” user action 140 on a mobile device. Screenshot 140 can be displayed by a web browser application executing on the mobile device and display the merchant's web site. In embodiments, the web site can include advertisement-specific information. For example, an advertisement for a Memorial Day sale can link to a Memorial Day sale web page displaying available products and prices. In this way, advertisement-specific information can be provided to the user and constantly updated by the merchant. Similarly, screenshot 140 can include a “share” user action, allowing the user to share the web site with another user.

FIG. 1F illustrates an exemplary screenshot of a “map location” user action 144 on a mobile device. The screen shot 144 can be displayed by a map application for displaying street, satellite or other maps. In one exemplary embodiment, screenshot 144 can display a street address and a geographic location of the advertiser on a street map, as illustrated. This allows the user to easily visualize where the merchant is located to take advantage of the advertisement. In embodiments, the map application can provide “search” and “directions” user actions 146. The search function allows the user to search for nearby businesses. This is useful if the user wants to see what else is nearby for itinerary planning purposes. The directions function allows the user to request directions to or from the provided address. For example, the user can request directions from the user's current location to the merchant location.

FIG. 1G illustrates an exemplary screenshot of a “show video” user action 150 on a mobile device. For example, the screenshot 150 can display a video clip for play back. The screen shot 150 can include a control bar 152, allowing the user to play, navigate, and share the video clip.

FIG. 1H illustrates another exemplary screenshot of a mobile device with an advertisement. Screenshot 160 can display a full article. In contrast, the above screen shots display a plurality of article headlines. In embodiments, screenshot 160 can include a “share” and “done” function. The share function allows the user to share the article with another user. The done function allows the user to exit the article, for example, after finishing reading the article. In some instances, screenshot 160 can include an article 162. The article 162 can include text, graphics, and other multimedia content. For example, the article 162 can be content as discussed below.

The screen shot 160 can include an advertisement 164. The advertisement 164 is displayed at the bottom of the screen as illustrated, but it will be appreciated that the advertisement 164 can be located anywhere on the screen of the mobile device.

FIG. 1I illustrates an exemplary screenshot of a mobile device with an advertisement 166. Screenshot 166 can display a full article, similar to the above figure. Screenshot 166 can include a “share” and “done” function 168. The share function allows the user to share the article with another user. The done function allows the user to exit the article, for example, after finishing reading the article. In some instances, screenshot 166 can include an article 170. The article 170 can include text, graphics, and other multimedia content. For example, the article 170 can be content as discussed below. Screenshot 166 can include an advertisement 172. The advertisement 172 is displayed at the bottom of the screen as illustrated, but it will be appreciated that the advertisement 172 can be located anywhere on the screen of the mobile device.

FIG. 1J illustrates an exemplary screenshot 10000 of an advertisement management system. For example, an advertiser may wish to advertise on a periodically updated content, such as a blog or RSS feed. In some instances, screenshot 1000 shows the first page of an advertising campaign creation process accessible to an advertiser. The screenshot 1000 includes an app cart 1002. For example, each application can provide display feature for advertisements on a mobile device, as well as any other functionality provided by a programmer. In some instances, screenshot 1000 includes an app listing 1004. In embodiments, an advertisement server lists available applications that are installed on user mobile devices that are able to display advertisements. The advertiser has the opportunity to select what mobile device applications he would like to advertise on. For example, certain applications may attract a certain user demographic relevant to the advertiser. A news application can be more relevant to news-related advertisements, while a punching game application can be more relevant to physical activity-related advertisements. In some instances, screenshot 1000 includes an existing campaign option 1006. The advertiser can have the option of adding to an existing advertising campaign.

FIG. 1K illustrates a second example screenshot of an advertisement management system 1010. Screenshot 1010 can provide a user interface to obtain advertising campaign information from the advertiser. The screen shot 1010 can include an ad and display time section 1012. In embodiments, the advertiser selects a banner ad for display in banner ad selection 1014. The screen shot 1010 can provide information such as banner ad parameters (size in pixels, advertisement platform, etc). The advertiser may also preview how the selected banner ad will appear in the applications selected above.

In embodiments, the advertiser also selects a text ad for display. For example, the text ad can be text entered by the advertiser. Similarly, the advertiser may preview the text ad as it would appear in the selected applications. It will be appreciated that multiple banner and text ads can be provided by the advertiser. For example, the multiple ads can be rotated or otherwise selected by the advertisement management server.

Display times section 1018 allows the advertiser to enter a desired display time. For example, time-sensitive advertisements (such as sales) can be displayed only before a certain deadline. Similarly, advertisements relevant to a specific time frame (lunch specials, weekend rates, etc) can be displayed only during a specified time window. Buttons 1020 allow the advertiser to proceed in the campaign selection or go back to the previous screen.

FIG. 1L illustrates a third example screenshot 1030 of an advertisement management system. A screen shot 1030 can provide a user interface to obtain advertising campaign information from the advertiser. In some instances, the screen shot 1030 can include a pick click targets section, where the advertiser can enter user action destinations. The advertiser can also view a preview of the app with the advertiser-entered user action destinations.

In embodiments, a text area 1034 can receive an advertiser-entered web site URL which defines an advertisement-associated web site. As discussed above, the advertisement can be associated with a web site, such as a merchant or sale website. Further, in embodiments, a text area 1036 can receive an advertiser-entered phone number. As discussed above, the advertisement can be associated with a contact phone number for the user to call.

In embodiments, a text area 1038 can be associated with an advertiser-entered map location. As discussed above, the advertisement can be associated with a geographical map location, allowing the user to display a map location relevant to the advertisement, such as a store location, with a mapping application. A text area 1040 can be associated with an advertiser-entered coupon URL. As discussed above, the advertisement can be associated with a coupon accessible to the user. The coupon can be available via the URL address. The coupon can be uploaded by the advertiser for storage and later retrieval by the advertisement management server.

In embodiments, text area 1042 can be associated with an advertiser-entered contact email address. As discussed above, the advertisement can be associated with an email address for users to contact with questions or other concerns. A text area 1044 can be associated with an advertiser-entered text messages. The advertiser can specify a text message to be sent to each user viewing the coupon. Alternatively, the user can initiate a text message to be sent to another user. Further, in embodiments, buttons 1046 allow the advertiser to proceed in the campaign selection or go back to the previous screen.

FIG. 1M illustrates a fourth exemplary screenshot 1050 of an advertisement management system. In some instances, screenshot 1050 can provide a user interface to obtain advertising campaign information from the advertiser. In embodiments, an advertiser can specify geographical targets in which a mobile device must be located before the advertisement is displayed. For example, mobile device location can be determined via location-determining modules, discussed below. This feature allows advertisers to fine-tune advertisement efforts. Furthermore, this allows improved relevance by only targeting geographically relevant advertisements. In some instances, screenshot 1050 includes a geographical target section 1052. The advertiser is allowed to select where to target the advertisement campaign. A graphical map 1054 can illustrate currently selected geographical targets. For example, currently selected targets can be highlighted on the map 1054.

In embodiments, geographical targets can be entered by name, zip code, or other descriptions in a text field 1056. By clicking the search button, the advertiser will be presented with a set of geographical target search results, below. Geographical target search results can be displayed in box 1058. The advertiser can select one or more geographical targets. The advertiser can select desired geographical targets and click button 1060 to add the selected geographical targets. Selected geographical targets 1062 can be displayed for advertiser review. The advertiser can select already selected geographical targets for deletion via button 1064. Buttons 1066 allow the advertiser to proceed in the campaign selection or go back to the previous screen.

FIG. 1N illustrates a fifth exemplary screenshot 1070 of an advertisement management system. In some instances, screenshot 1070 can provide a user interface to obtain advertising campaign information from the advertiser. In embodiments, the advertiser can determine an amount to spend on the campaign. The advertiser can enter a maximum daily budget 1072. This can be a hard or soft cap on how much the advertiser will spend on any day and provide certainty in the advertiser's budget.

In some instances, the advertiser can enter a cost per click for each selected app in 1074. It will be appreciated that alternative forms of budgeting for the advertising campaign are possible. For example, there can be a global cost per click across all apps. Alternatively, cost per click can be further defined by user demographic information. Buttons 1076 allow the advertiser to proceed in the campaign selection or go back to the previous screen.

FIG. 1O illustrates a sixth exemplary screenshot 1080 of an advertisement management system. A screen shot 1080 can provide a user interface to review advertiser-entered information. In some instances, screenshot 1080 can include a preview 1082 allowing the advertiser to preview the campaign. The advertiser can enter a campaign name. The screenshot 1080 can include a selected banner ad 1084 to be displayed in the campaign. The screenshot 1080 can include a selected text ad 1086 to be displayed in the campaign.

In some instances, the screen shot 1080 can include one or more of the following: click targets 1088, as entered by the advertiser discussed above; geographical targets 1090, as entered by the advertiser discussed above; a maximum daily budget 1092, along with selected apps and associated CPC, as entered by the advertiser discussed above, etc. Button 1094 allows the advertiser to save and begin the advertisement campaign.

FIG. 1P illustrates a seventh exemplary screenshot 1100 of an advertisement management system. In some instances, screenshot 1100 can provide a user interface for an advertiser to manage existing advertisement campaigns. In some instances, screenshot 1100 can include a listing of all defined advertisement campaigns 1102. Each campaign can be paused, resumed, and deleted via buttons 1104. In embodiments, various filtering functionality is available via inputs 1106, allowing the advertiser to view campaigns within a specified time frame. The available campaigns can be sorted by name, budget, aver CPC, impressions, etc. via sorting buttons 1108. The screen shot 1100 can provide a suggested ad locations 1110. This feature allows the advertisement management system to suggest additional geographical targets and apps that are relevant to the campaign's targets. Button 1112 allows the advertiser to add the selected geographical targets and apps to the advertisement campaign.

FIG. 1Q illustrates an eighth exemplary screenshot 1120 of an advertisement management system. A screen shot 1120 can provide a user interface to obtain advertising campaign information from the advertiser. For example, the advertiser can elect to edit an existing campaign. A selected campaign 1122 is selected by the advertiser for detailed viewing, which brings up the associated banner and text ads, along with the select apps and advertiser-inputted CPCs and other details. In embodiments, the advertiser can select additional banners to the campaign in section 1124. New banner ads can be uploaded via tool 1126. The advertiser can also select click targets associated with the uploaded banner ad. Button 1128 allows the advertiser to save the uploaded ads and advertiser-inputted advertisement click targets.

FIG. 1R illustrates a ninth exemplary screenshot of an advertisement management system. In some instances, screenshot 1130 can provide a user interface to obtain advertising campaign information from the advertiser. For example, the advertiser can elect to edit an existing campaign. In embodiments, the advertiser can update a maximum daily budget at 1132. The maximum daily budget can be as discussed above. The advertiser can update a CPC for each selected app at 1134. The CPC and selected apps can be as discussed above. The advertiser can update geographical targets for the campaign at 1136. Geographical targets can be as discussed above. Button 1138 allows the advertiser to save the uploaded ads and advertiser-inputted advertisement click targets.

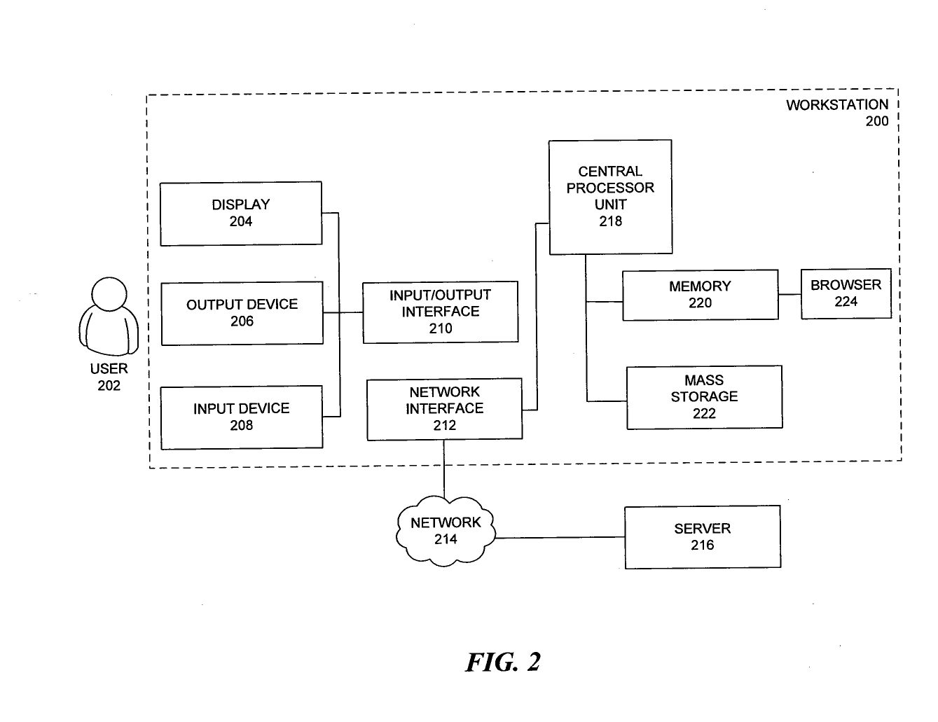

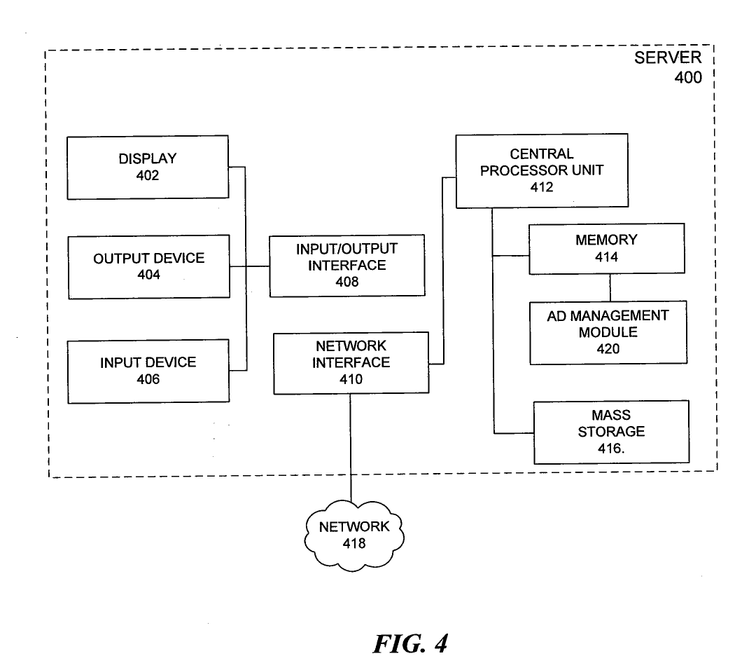

FIG. 2 illustrates an example prior art workstation interacting with an advertisement management system. The workstation 200 can provide a user interface to a user 202. In one example, the workstation 200 can be configured to function as a user interface between the user 202 and at least one server. For example, the workstation 200 can communicate with a server as illustrated in FIG. 4.

The workstation 200 can be a computing device such as a server, a personal computer, desktop, laptop, a personal digital assistant (PDA) or other computing device. The workstation 200 is accessible to the user 202 and provides a computing platform for various applications. The workstation 200 can include a display 204. The display 204 can be physical equipment that displays viewable images and text generated by the workstation 200. For example, the display 204 can be a cathode ray tube or a flat panel display such as a TFT LCD. The display 204 includes a display surface, circuitry to generate a picture from electronic signals sent by the workstation 200, and an enclosure or case. The display 204 can interface with an input/output interface 210, which forwards data from the workstation 200 to the display 204.

The workstation 200 can include one or more output devices 206. The output device 206 can be hardware used to communicate outputs to the user. For example, the output device 206 can include speakers and printers, in addition to the display 204 discussed above. The workstation 200 can include one or more input devices 208. The input device 208 can be any computer hardware used to translate inputs received from the user 202 into data usable by the workstation 200. The input device 208 can be keyboards, mouse pointer devices, microphones, scanners, video and digital cameras, etc.

The workstation 200 includes an input/output interface 210. The input/output interface 210 can include logic and physical ports used to connect and control peripheral devices, such as output devices 206 and input devices 208. For example, the input/output interface 210 can allow input and output devices 206 and 208 to be connected to the workstation 200. In embodiments, the workstation 200 includes a network interface 212. The network interface 212 includes logic and physical ports used to connect to one or more networks. For example, the network interface 212 can accept a physical network connection and interface between the network and the workstation by translating communications between the two. Example networks can include Ethernet, or other physical network infrastructure. Alternatively, the network interface 212 can be configured to interface with a wireless network. Alternatively, the workstation 200 can include multiple network interfaces for interfacing with multiple networks.

In embodiments, the workstation 200 communicates with a network 214 via the network interface 212. The network 214 can be any network configured to carry digital information. For example, the network 214 can be an Ethernet network, the Internet, a wireless network, a cellular data network, or any Local Area Network or Wide Area Network. Alternatively, the workstation 200 can be a client device (i.e., thin client) in communications with a server over the network 214. Thus, the workstation 200 can be configured for lower performance (and thus have a lower hardware cost) and the server provides necessary processing power and resources. The workstation 200 communicates with a server 216 via the network interface 222 and the network 214. The server 216 can be computing device as illustrated in FIG. 4.

The workstation 200 includes a central processing unit (CPU) 218. The CPU 218 can be an integrated circuit configured for mass-production and suited for a variety of computing applications. The CPU 218 can be installed on a motherboard within the workstation 200 and control other workstation components. The CPU 218 can communicate with the other workstation components via a bus, a physical interchange, or other communication channel.

The workstation 200 includes a memory 220. The memory 220 can include volatile and non-volatile memory accessible to the CPU 218. The memory can be random access and store data required by the CPU 218 to execute installed applications. In an alternative, the CPU 218 can include on-board cache memory for faster performance. The workstation 200 includes mass storage 222. The mass storage 222 can be volatile or non-volatile storage configured to store large amounts of data. The mass storage 222 can be accessible to the CPU 218 via a bus, a physical interchange, or other communication channel. For example, the mass storage 222 can be a hard drive, a RAID array, flash memory, CD-ROMs, DVDs, HD-DVD or Blu-Ray mediums.

The workstation 200 can include a browser 224 configured to function as a user interface between the user 202 and the server 216. The browser 224 can interface with an advertisement management server. In operation, the user 202 can be a publisher responsible for publishing blog entries or other content. The content is uploaded to the server 216 for distribution to mobile devices over a network. Alternatively, the user 202 can be an advertiser, who submits advertisements and advertisement criteria to the server 216 for distribution. In one example embodiment, the advertisements are displayed along with content, and are first approved by the publisher.

FIG. 3 illustrates an exemplary mobile device 300 for displaying web feeds and advertisements. The mobile device 300 can be a cellular phone, a personal digital assistant (PDA), or a similar portable device used by a user 302. The mobile device 300 is configured to display content such as blog entries and advertisements. As illustrated here, the mobile device 300 can include a processor 304. The processor 304 can be a general purpose processor configured to execute computer-readable instructions operating the mobile device 300 and associated peripherals, including computing an acceleration measurement from an accelerometer reading. It will be appreciated that any number of processors can be included in the mobile device 300, including specialized processors. The processor 304 can also be configured to execute the RSS application 322, as discussed below.

The mobile device 300 can include a location determining module 306. The module 306 can be a GPS receiver module configured to receive GPS signals and calculate a physical location of the mobile device 300 based on the received GPS signals and an internal clock time. The physical location calculation can be optimized by, for example, averaging the GPS signals over time or incorporating a signal from a known nearby location. Alternatively, the module 306 can calculate a physical location by cellular signal triangulation or via short-range wireless network detection.

The mobile device 300 can include a clock 308. The clock 308 can provide a local time. The clock 308 can also provide an internal time for use with the GPS module. The clock 308 can be periodically updated from a server in communications with the mobile device 300. The mobile device 300 includes an accelerometer 310. The accelerometer 310 can be configured to detect physical movement of the mobile device 300 and convert the movement into digital signals transmitted to the processor 304.

In embodiments, the mobile device 300 includes additional sensors 312. Additional sensors can include audio input devices or optical input devices. Audio input devices can include microphones, thermometers and other environmental sensors, etc. Optical input devices can include cameras or light sensors. The sensors 312 can be configured to detect appropriate input and convert the input into input signals transmitted to the processor 302.

The mobile device 300 can include a network interface 314. For example, the network interface 314 can communicate with a cellular wireless network, a wired network such as Ethernet, or a short range wireless network such as Bluetooth or Wi-Fi. The mobile device 300 can include multiple network interfaces or a network interface configured to interface with multiple networks. Wireless network interfaces can communicate via an antenna 330. An Ethernet network allows the mobile device 300 to communicate when plugged in. The mobile device 300 can be assigned an IP address on the wired network. A short-range wireless network can be, for example, a Wi-Fi, Wi-Bree or Bluetooth network.

The mobile device 300 can include an input/output interface 316. The interface 316 can receive user inputs from an input device and convert the user inputs into user commands. For example, input devices can include a touch screen display, a keypad, a microphone, an optical device, a pointer device, a scroll wheel, or other input devices.

The interface 316 can also transmit output to an output device in a form accessible to the user 302. For example, output devices can include a touch screen, a display screen, a speaker, an audio-out jack, an electro-mechanical motor for providing tactile output, or other output devices. The mobile device 300 can include a memory 318. The memory 318 can be read-only or read-write, persistent or volatile storage memory accessible to the processor 304. The memory 318 can store data required by the mobile device 300 for operation and applications for execution. The mobile device 300 can include an antenna 320. The antenna 330 can be configured to transmit and receive wireless signals from a wireless network.

In embodiments, the mobile device 300 can store a RSS application 322 for execution. The RSS application 322 can receive and display content and advertisements via the I/O interface 316 to the user 302. The content can be blog entries, news articles, or any other type of content useful to the user 302. The advertisement can be displayed alongside the content. In operation, the mobile device 300 can collect information from its various sensors, such as a geographical location, a local time, a user's physical acceleration (indicating whether the user is sitting still, walking, running, driving, or taking another mode of transportation), and local environmental conditions (temperature, humidity, etc). Such information can be transmitted over the network interface 314 to a server.

FIG. 4 illustrates an exemplary server 400 for providing an advertisement management system. The server 400 can interact with an advertisement data store, a content data store, a publisher, an advertiser, and a user to provide an advertisement management system. The server 400 includes a display 402. The display 402 can be equipment that displays viewable images, graphics, and text generated by the server 400 to a user. For example, the display 402 can be a cathode ray tube or a flat panel display such as a TFT LCD. The display 402 includes a display surface, circuitry to generate a viewable picture from electronic signals sent by the server 400, and an enclosure or case. The display 402 can interface with an input/output interface 408, which converts data from a central processor unit 412 to a format compatible with the display 402.

The server 400 includes one or more output devices 404. The output device 404 can be any hardware used to communicate outputs to the user. For example, the output device 404 can be audio speakers and printers or other devices for providing output. The server 400 includes one or more input devices 406. The input device 406 can be any computer hardware used to receive inputs from the user. The input device 406 can include keyboards, mouse pointer devices, microphones, scanners, video and digital cameras, etc.

The server 400 includes an input/output interface 408. The input/output interface 408 can include logic and physical ports used to connect and control peripheral devices, such as output devices 404 and input devices 406. For example, the input/output interface 408 can allow input and output devices 404 and 406 to communicate with the server 400.

The server 400 includes a network interface 410. The network interface 410 includes logic and physical ports used to connect to one or more networks. For example, the network interface 410 can accept a physical network connection and interface between the network and the workstation by translating communications between the two. Example networks can include Ethernet, or other physical network infrastructure. Alternatively, the network interface 410 can be configured to interface with wireless network. Alternatively, the server 400 can include multiple network interfaces for interfacing with multiple networks.

In embodiments, the network interface 410 communicates over a wired network and a cellular network. It will be appreciated that the server 400 can communicate over any combination of wired, wireless, or other networks. The server 400 includes a central processing unit (CPU) 412. The CPU 412 can be an integrated circuit configured for mass-production and suited for a variety of computing applications. The CPU 412 can sit on a motherboard within the server 400 and control other workstation components. The CPU 412 can communicate with the other workstation components via a bus, a physical interchange, or other communication channel.

The server 400 includes memory 414. The memory 414 can include volatile and non-volatile memory accessible to the CPU 412. The memory can be random access and provide fast access for graphics-related or other calculations. In an alternative, the CPU 412 can include on-board cache memory for faster performance. The server 400 includes mass storage 416. The mass storage 416 can be volatile or non-volatile storage configured to store large amounts of data. The mass storage 416 can be accessible to the CPU 412 via a bus, a physical interchange, or other communication channel. For example, the mass storage 416 can be a hard drive, a RAID array, flash memory, CD-ROMs, DVDs, HD-DVD or Blu-Ray mediums.

The server 400 communicates with a network 418 via the network interface 412. The network 418 can be as discussed above. The server 400 can communicate with a mobile device over the cellular network 418. Alternatively, the network interface 410 can communicate over any network configured to carry digital information. For example, the network interface 410 can communicate over an Ethernet network, the Internet, a wireless network, a cellular data network, or any Local Area Network or Wide Area Network.

In embodiments, an advertisement management module 420 can be stored in memory 414 for execution by the CPU 412. The module 420 can function as described below and provide advertisement management to advertisers, publishers, and users.

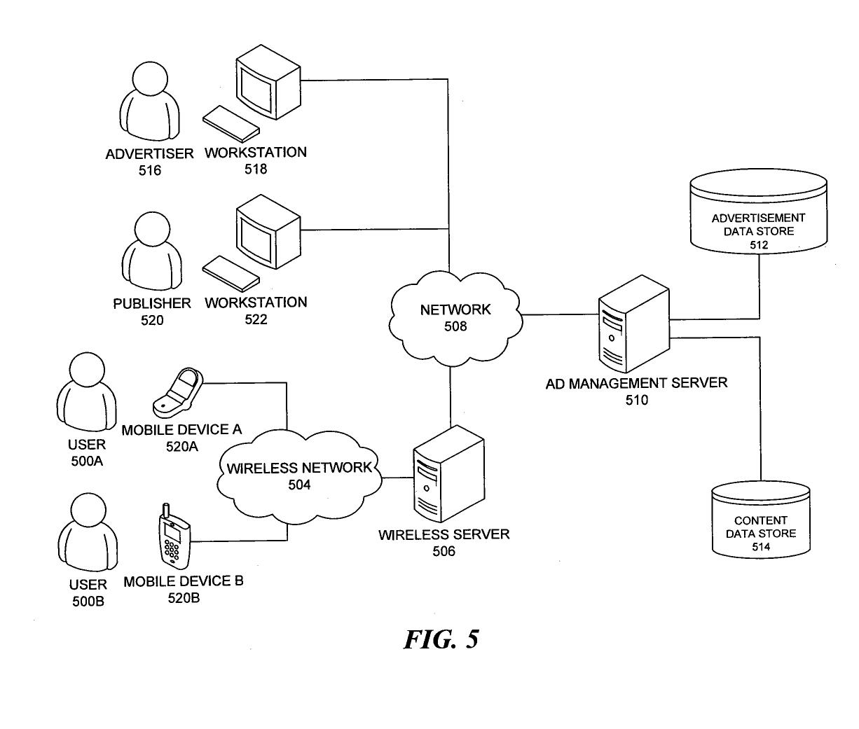

FIG. 5 illustrates an example system for managing advertisements on mobile devices. The system allows advertisers and publishers to distribute advertisement along with content for display on mobile devices accessible to users. Users 500A and 500B can access mobile device A 502A and mobile device B 502B. For example, the mobile devices can be as illustrated in FIG. 3. It will be appreciated that while only two users and two mobile devices are illustrated, the system can support any number of users and mobile devices.

In embodiments, the mobile devices 502A and 502B can communicate via a wireless network 504 with a wireless server 506. Together, the wireless network 504 and the wireless server 506 can comprise a cellular network, including geographically separated cell towers for communicating with mobile devices and infrastructure for communicating with other networks. The wireless network 504 can communicate on a variety of wireless protocols, including GSM and CDMA.

A cellular network can be a radio network made up of a number of radio cells, each served by at least one fixed-location transceiver known as a cell site or base station. These cells cover different geographical areas to provide radio coverage over a wider area than the area of one cell, so that a variable number of portable transceivers can be used in any one cell and moved through more than one cell during transmission. The cellular network can be managed by the wireless server 506. The wireless server 506 can be in communication with a network 508, which can be one or more networks configured to carry digital information. For example, the network 508 can be the Internet. It will be appreciated that the wireless server 506 can be in communication with other networks, for example, to forward calls made on the mobile devices to another network or to retrieve data responsive to user requests.

An advertisement management server 510 can be in communication with the network 508. The server 510 can be as discussed in FIG. 4 and configured to provide advertisement management functionality as discussed. The server 510 can be in communication with an advertisement data store 512. The advertisement data store 512 can be any form of computer-readable storage medium and store a plurality of advertisements and their associated metadata, as discussed above. The advertisements can be indexed or otherwise organized for fast access and retrieval.

The server 510 can be in communication with a content data store 514. The content data store 514 can be any form of computer-readable storage medium and store a plurality of content and their associated metadata, as discussed above. The content can be indexed or otherwise organized for fast access and retrieval. Example contents include blog entries, news articles, or other content useful to a user. An advertiser 516 can access a workstation 518 to communicate with the server 510 over the network 508. Similarly, a publisher 520 can access a workstation 522 to communicate with the server 510 over the network 508. The workstations 518 and 522 can be as illustrated in FIG. 2.

In some instances, the advertiser 516 can access advertising functionality provided by the server 510, such as submitting advertisements for display, making payments for advertisements, viewing advertisement analytics, etc., as discussed. The publisher 520 can access publishing and advertisement management functionality provided by the server 510, such as uploading content to the content data store 514, viewing proposed advertisements from the advertiser 516, approving advertisements for inclusion into the advertisement data store 512, etc., as discussed. It will be appreciated that the advertisement data store 512 and the content data store 514 can communicate the advertisement management server 510 over a network, as illustrated, or be integral to the advertisement management server 510.

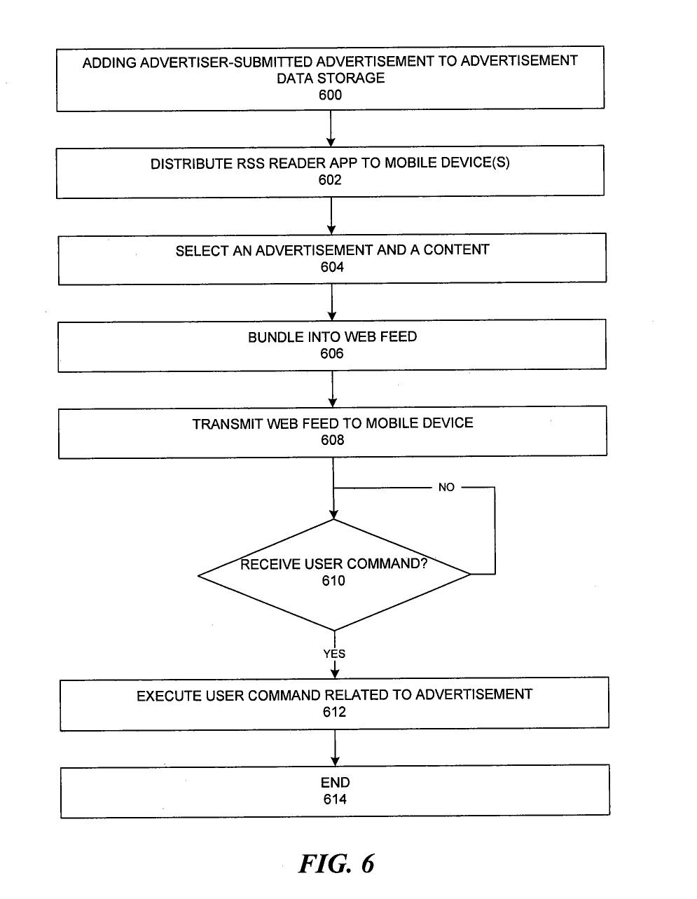

FIG. 6 illustrates an exemplary process for defining an advertisement campaign for executing. In embodiments, the procedure can execute on an advertisement management server, as discussed above. In 600, the server optionally adds an advertiser-submitted advertisement to an advertisement data pool. For example, an advertiser can submit an advertisement as discussed above. In one embodiment, the publisher who manages the app or RSS reader that will display the advertisement will have approval rights before any advertisements are displayed. Once the advertisement is approved, it is added to the advertisement data store.

In 602, the server optionally distributes an RSS reader to one or more mobile devices. For example, an RSS reader can be configured to receive regularly published materials in a web feed. The RSS reader also displays advertisements, as discussed above. In an alternative example, the server optionally distributes applications with other functionality that can also receive and display advertisements. As discussed, a news application can regularly display the latest news articles. Other applications include games, utilities, etc., which are configured to display advertisements.

In 604, the server selects an advertisement from an advertisement data store and a content from a content data store. For example, the advertisement can be selected based on a nature of the selected content and advertiser-selected campaign parameters discussed above. It will be appreciated that any number of advertisements and contents can be selected.

In 606, the server bundles the selected advertisement and content into a web feed. For example, the web feed can be an RSS feed. Alternatively, the web feed can be a proprietary format used to communicate with previously distributed apps, discussed above. In 608, the server transmits the web feed to a mobile device. As discussed above, the mobile device can execute an app or an RSS reader for receiving, parsing, and displaying the advertisement and content. In 610, the server tests whether a user command has been received. Each advertisement can be associated with a set of user commands, such as view coupon, share, map, etc. as discussed above. If a user command is received, the server proceeds to 612. If no user command is received, the server remains at 610.

In embodiments, the server can exit the procedure after the web feed is distributed. Another procedure can be executed to service user commands from the mobile device. In 612, the server executes the received user command related to the advertisement. Example user commands can be as discussed above. In 614, the server exits the procedure.

The specific embodiments described in this document represent examples or embodiments of the present invention, and are illustrative in nature rather than restrictive. In the above description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the present invention. Features and aspects of various embodiments may be integrated into other embodiments, and embodiments illustrated in this document may be implemented without all of the features or aspects illustrated or described. It will be appreciated to those skilled in the art that the preceding examples and embodiments are exemplary and not limiting.

While the system, apparatus and method have been described in terms of what are presently considered to be the most practical and effective embodiments, it is to be understood that the disclosure need not be limited to the disclosed embodiments. It is intended that all permutations, enhancements, equivalents, combinations, and improvements thereto that are apparent to those skilled in the art upon a reading of the specification and a study of the drawings are included within the true spirit and scope of the present invention. The scope of the disclosure should thus be accorded the broadest interpretation so as to encompass all such modifications and similar structures. It is therefore intended that the application includes all such modifications, permutations and equivalents that fall within the true spirit and scope of the present invention.

What is claimed is:

1. A system for distributing advertisements, comprising:
an advertisement data store for storing a set of advertisements, each advertisement associated with user action data;
a content data store for storing a set of contents; and
an advertisement management server operatively coupled to the advertisement data store and the content data store, the advertisement management server configured to:
select at least one advertisement and at least one content for bundling into a web feed,
transmit the web feed to a mobile device via a wireless network for display, wherein the advertisement and the content are displayed together,
responsive to receiving a user command, executing a user-selected action in conjunction with the user action data.

2. The system of claim 1, wherein the user-selected action is at least one of:
requesting an advertisement-related coupon;
requesting an advertisement-related reminder;
displaying an advertisement-related video;
displaying an advertisement-related map location;
viewing an advertisement-related website;
calling an advertisement-related phone number;
emailing an advertisement-related contact email address;
requesting additional advertisement information; or
sharing the advertisement with another user.

3. The system of claim 1, wherein the web feed is in a standardized publishing web feed format, the format including a Really Simple Syndication (RSS) format.

4. The system of claim 3, further comprising:
distributing an RSS reader application to the mobile device, wherein the RSS reader application receives and displays the web feed responsive to user inputs.

5. The system of claim 2, wherein the contents are blog entries.

6. The system of claim 1, wherein an advertiser can submit an advertisement for inclusion in the advertisement data store via a web interface.

7. The system of claim 1, wherein the at least one advertisement is selected based, in part, on stored user information associated with the mobile device and user information transmitted to the advertisement management server by the mobile device.

8. The system of claim 1, wherein the content is a video clip and the advertisement is superimposed over the video clip.

9. A method for distributing advertisements, comprising:
storing a set of advertisements in an advertisement data store, each advertisement associated with user action data;
storing a set of contents in a content data store;
selecting at least one advertisement and at least one content for bundling into a web feed in an advertisement management server, wherein the advertisement management server is operatively coupled to the advertisement data store and the content data store;
transmitting the web feed to a mobile device via a wireless network for display, wherein the advertisement and the content are displayed together; and
responsive to receiving a user command, executing a user-selected action in conjunction with the user action data.

10. The method of claim 9, wherein the user-selected action is at least one of:
requesting an advertisement-related coupon;
requesting an advertisement-related reminder;
displaying an advertisement-related video;
displaying an advertisement-related map location;
viewing an advertisement-related website;
calling an advertisement-related phone number;
emailing an advertisement-related contact email address;
requesting additional advertisement information; or
sharing the advertisement with another user.

11. The method of claim 9, wherein the web feed is in a standardized publishing web feed format, the format including a Really Simple Syndication (RSS) format.

12. The method of claim 11, further comprising:
distributing an RSS reader application to the mobile device, wherein the RSS reader application receives and displays the web feed responsive to user inputs.

13. The method of claim 11, wherein the contents are blog entries.

14. The method of claim 9, wherein an advertiser can submit an advertisement for inclusion in the advertisement data store via a web interface.

15. The method of claim 9, wherein the at least one advertisement is selected based, in part, on stored user information associated with the mobile device and user information transmitted to the advertisement management server by the mobile device.

16. The method of claim 15, wherein the content is a video clip and the advertisement is superimposed over the video clip.

17. A system for distributing advertisements, comprising:
an advertisement data store for storing a set of advertisements, each advertisement associated with user action data;
a content data store for storing a set of contents; and
an advertisement management server operatively coupled to the advertisement data store and the content data store, the advertisement management server configured to:
select at least one advertisement and at least one content for bundling into a web feed,
transmit the web feed to a mobile device via a wireless network for display, wherein the advertisement and the content are displayed together,
responsive to receiving a user command, executing a user-selected action in conjunction with the user action data, wherein the user-selected action is at least one of: requesting an advertisement-related coupon, requesting an advertisement-related reminder, displaying an advertisement-related video, displaying an advertisement-related map location, viewing an advertisement-related website, calling an advertisement-related phone number, emailing an advertisement-related contact email address, requesting additional advertisement information, and sharing the advertisement with another user.
